(19) United States
(12) Patent Application Publication
(10) Pub. No.: US 2012/0310843 A1
(43) Pub. Date: Dec. 6, 2012

(54) METHOD AND APPARATUS FOR UPDATING PRICES FOR KEYWORD PHRASES

(75) Inventors: Surya Josyula, Cupertino, CA (US); Jun Wang, San Jose, CA (US); Kanji Uchino, San Jose, CA (US)

(73) Assignee: Fujitsu Limited, Kanagawa (JP)

(21) Appl. No.: 13/152,946

(22) Filed: Jun. 3, 2011

(51) Int. Cl. G06Q 99/00

(52) U.S. Cl. 705/306

(57) ABSTRACT

A method for updating prices for phrases may begin by receiving, at a computing device, a real-time data feed comprising a plurality of messages. The method may continue by detecting, by the computing device, a topic associated with a message in the plurality of messages using natural language processing. The topic may indicate the subject of the message. The method may continue by calculating, by the computing device, a score for the topic using temporal data associated with the message. The score may indicate the popularity of the topic. The method may continue by extracting, by the computing device, a keyword phrase from the topic. The method may conclude by determining, by the computing device, a price associated with the keyword phrase using the score.

### TECHNICAL FIELD

This disclosure relates generally to Internet keyword phrase bidding, and more particularly to a method of updating prices for Internet keyword phrases using natural language processing on real-time data feeds.

### BACKGROUND

As use of the Internet has grown, so has the demand on keyword phrases used in Internet searches. Individuals and companies alike now bid for keyword phrases at auctions. When a user searches a particular keyword phrase on the Internet, the results may highlight or give preferential treatment to the websites of those who have won the keyword phrase at auction.

### SUMMARY

According to one embodiment, a method for updating prices for keyword phrases may begin by receiving, at a computing device, a real-time data feed comprising a plurality of messages. The method may continue by detecting, by the computing device, a topic associated with a message in the plurality of messages using natural language processing. The topic may indicate the subject of the message. The method may continue by calculating, by the computing device, a score for the topic using temporal data associated with the message. The score may indicate the popularity of the topic. The method may continue by extracting, by the computing device, a keyword phrase from the topic. The method may conclude by determining, by the computing device, a price associated with the keyword phrase using the score.

According to another embodiment, an apparatus is provided comprising a receiver, a language processor, a ranker, and an engine. The receiver may be configured to receive a real-time data feed. The real-time data feed may comprise a plurality of messages. The language processor may be configured to detect a topic associated with a message in the plurality of messages using natural language processing. The topic may indicate the subject of the message. The language processor may be further configured to extract a keyword phrase from the topic. The ranker may be configured to calculate a score for the topic using temporal data associated with the message. The score may indicate the popularity of the topic. The engine may be configured to determine a price associated with the keyword phrase using the score.

Technical advantages of certain embodiments of the present disclosure include updating prices for Internet keyword phrases using real-time data feeds. Specifically, the prices may be updated to more accurately reflect the popularity of particular keyword phrases in real-time. Other technical advantages will be readily apparent to one skilled in the art from the following figures, descriptions, and claims. Moreover, while specific advantages have been enumerated above, various embodiments may include all, some or none of the enumerated advantages.

### BRIEF DESCRIPTION OF THE DRAWINGS

For a more complete understanding of the present disclosure and its advantages, reference is now made to the following description, taken in conjunction with the accompanying drawings, in which:

FIG. 1 is a schematic diagram of a system for pricing keyword phrases.

FIG. 2 is an illustration of some of the logical components of the computing device in the system of FIG. 1.

FIG. 3 is an illustration of some of the logical components of the ranker of the computing device of FIG. 2.

FIG. 4 is a flowchart illustrating a method of updating prices for keyword phrases using the system of FIG. 1.

### DETAILED DESCRIPTION

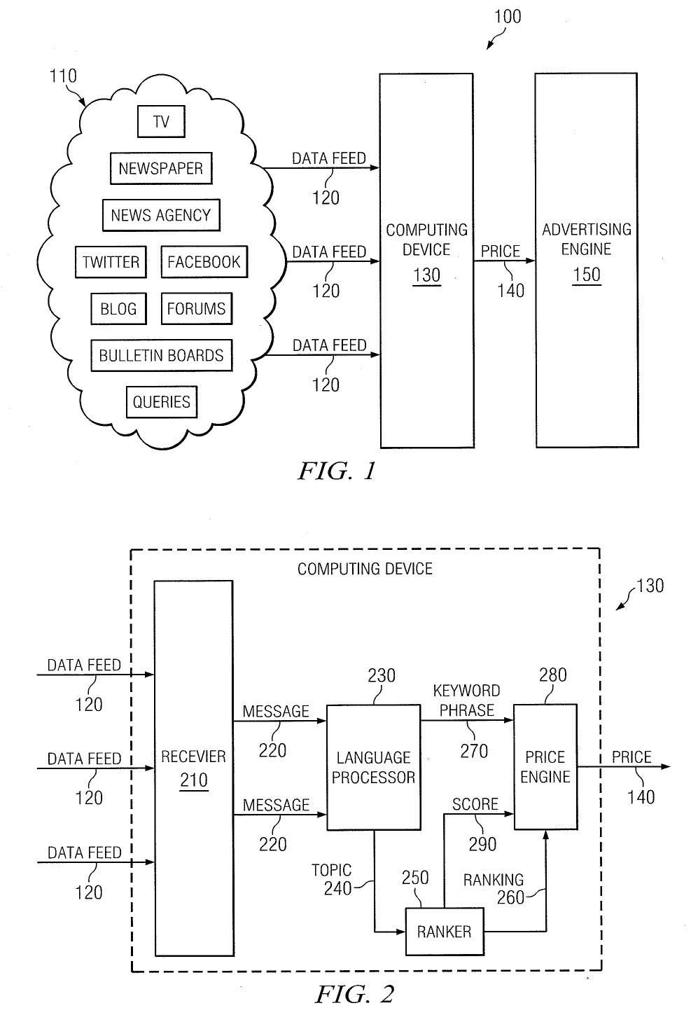

FIG. 1 is a schematic diagram of a system 100 for pricing keyword phrases. As provided in FIG. 1, the system may include a network 110, a computing device 130, and an advertising engine 150. In particular embodiments, computing device 130 may download data feeds 120 from network 110. Computing device 130 may process data feeds 120 to generate prices 140 for particular keyword phrases. Advertising engine 150 may use prices 140 to administer auctions for keyword phrases or for other purposes.

In particular embodiments, network 110 may be the Internet. In some embodiments, network 110 may include information sources such as main stream media sources, social media sources, or other communication sources. As an example and not by way of limitation, network 110 may include newspapers, news agencies, Twitter, Facebook, blogs, forums, or Bulletin Board Systems (BBS). In particular embodiments, the information sources may produce data feeds 120. In some embodiments, data feeds 120 may be real-time data feeds 120. Data feeds 120 may include messages. As an example and not by way of limitation, data feed 120 from a news agency may include news articles.

In particular embodiments, computing device 130 may be configured to process data feeds 120 from network 110 to generate a price 140. In particular embodiments, computing device 130 may be configured to extract a message from data feed 120 and to detect a topic associated with the message using natural language processing. The topic may indicate the subject of the message. As an example and not by way of limitation, computing device 130 may be configured to detect that an article from a news agency is about an oil spill. In particular embodiments, computing device 130 may be configured to extract a keyword phrase from the topic. As an example and not by way of limitation, computing device 130 may extract the keyword phrase “oil” from the topic “oil spill.” In some embodiments, computing device 130 may be configured to extract a plurality of keyword phrases from the topic. In particular embodiments, computing device 130 may determine a price 140 associated with the keyword phrase. Because computing device 130 may process real-time data feeds 120 to determine price 140, price 140 may more accurately reflect the popularity or relevance of the keyword phrase. In particular embodiments computing device 130 may pass price 140 onto an advertising engine 150.

In particular embodiments, advertising engine 150 may be configured to administer the bidding process for keyword phrases. Advertising engine 150 may use prices 140 from computing device 130 to assess bids for keyword phrases. In particular embodiments, advertising engine 150 may administer auctions for keyword phrases more efficiently by using prices 140 from computing device 130. Because prices 140 may more accurately reflect the popularity or relevance of a keyword phrase, buyers with secret information about the keyword phrase will be less likely to win an auction with a low bid.

FIG. 2 is an illustration of some of the logical components of the computing device 130 in the system 100 of FIG. 1. As provided in FIG. 2, computing device 130 may include a receiver 210, a language processor 230, a ranker 250, and an engine, for example, a pricing engine 280. In particular embodiments, receiver 210 may be configured to receive a plurality of data feeds 120 and to extract messages 220 from data feeds 120. Language processor 230 may be configured to process messages 220. In particular embodiments, language processor 230 may be configured to detect a topic 240 and to extract a keyword phrase 270. Ranker 250 may determine a ranking 260 and a score 290 for topic 240. Pricing engine 280 may use ranking 260 and/or score 290 to determine a price 240 for keyword phrase 270.

In particular embodiments, receiver 210 may be configured to receive a plurality of data feeds 120. Each data feed 120 may include a plurality of messages 220. In particular embodiments, receiver 210 may be configured to extract messages 220 from data feeds 120. As an example and not by way of limitation, receiver 210 may extract news articles from a data feed 120 from a news agency. Receiver 210 may be configured to pass messages 220 to language processor 230.

In particular embodiments, language processor 230 may be configured to process messages 220. As an example and not by way of limitation, language processor 230 may process messages 220 by using natural language processing techniques, such as, for example, the natural language algorithms of “Introduction to Information Retrieval” by Manning, Raghavan, and Schiitze (July, 2008). In particular embodiments, language processor 230 may be configured to detect a topic 240 from a message 220. Topic 240 may indicate the subject of message 220. As an example and not by way of limitation, language processor 230 may detect the topic 240 “oil spill” for a news article detailing the plight of marine life after an oil spill. In particular embodiments, language processor 230 may be configured to extract a keyword phrase 270 from topic 240. In some embodiments, language processor 230 may examine text from message 220 to extract keyword phrase 270. As an example and not by way of limitation, language processor 230 may be configured to extract the keyword phrase 270 “oil” from the topic 240 “oil spill.” In particular embodiments, language processor 230 may be configured to pass topic 240 to ranker 250. Ranker 250 may be configured to determine ranking 260 and score 290 for topic 240. Ranker 250 may be embodied in computer-readable media. In particular embodiments, ranking 260 may indicate the popularity or relevance of topic 240. In some embodiments, language processor 230 may be further configured to pass keyword phrase 270 to pricing engine 280.

In particular embodiments, pricing engine 280 may be configured to determine price 140 for keyword phrase 270 from ranking 260 and/or score 290. Price 140 may indicate a predicted click-through rate for keyword phrase 270. In some embodiments, a higher determined price 140 may indicate a higher predicted click-through rate. In particular embodiments, price 140 may increase for a higher ranking 260 and/or score 290. Price 140 may more accurately reflect the true market value of keyword phrase 270 because ranking 260 and score 290 may more accurately measure the popularity or relevance of keyword phrase 270 by using information from real-time data feeds 120. By using price 140, an auction system may prevent a buyer who has information that other buyers do not from underbidding on a keyword phrase 270 that is about to become popular or relevant.

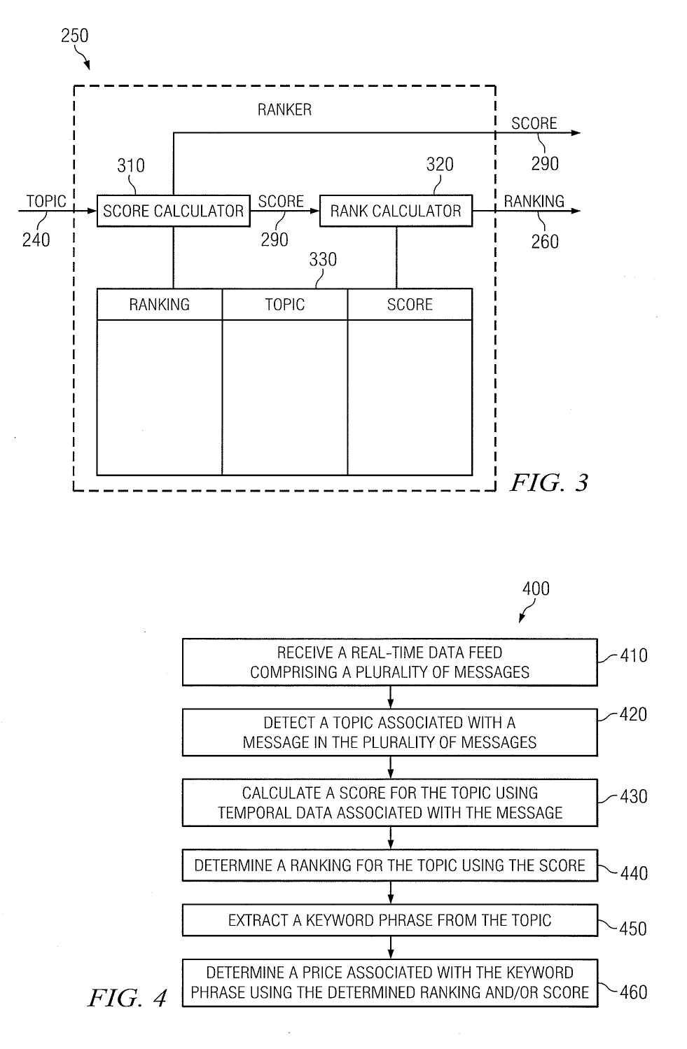

FIG. 3 is an illustration of some of the logical components of the ranker 250 of the computing device 130 of FIG. 2. As provided in FIG. 3, ranker 250 may include a score calculator 310, a rank calculator 320, and a ranking-topic-score table 330. In particular embodiments, score calculator 310 may be configured to calculate score 290 from topic 240. Rank calculator 320 may be configured to determine a ranking 260 from score 290. Both score calculator 310 and rank calculator 320 may be configured to read from and write to ranking-topic-score table 330.

In particular embodiments, score calculator 310 may be configured to calculate score 290 for topic 240. In particular embodiments, score calculator 310 may use temporal data associated with message 220 from which topic 240 was determined to calculate score 340. As an example and not by way of limitation, score calculator 310 may use the timestamp associated with message 220 to calculate score 290. As another example and not by way of limitation, score calculator 310 may use the time of download associated with message 220 to calculate score 290. In some embodiments, score calculator 310 may be configured to calculate a higher score for topic 240 the more recent message 220 was downloaded. As an example and not by way of limitation, score calculator 310 may use the following formula to calculate score 290:

$$Score = {ω}_{news} {\sum }_{i = 1}^{{N}_{news}} {e}^{- {λ}_{news} ( t - {t}_{i}^{news} )} + {ω}_{Blog} {\sum }_{j = 1}^{{N}_{Blog}} {e}^{- {λ}_{Blog} ( t - {t}_{j}^{Blog} )} + {ω}_{BBS} {\sum }_{k = 1}^{{N}_{BBS}} {e}^{- {λ}_{BBS} ( t - {t}_{k}^{BBS} )} ,$$

where N_{news} is the total number of messages 220 related to topic 240 from data feed 120 from a source of news, N_{Blog} is the total number of messages 220 related to topic 240 from data feed 120 from a blog, N_{BBS} is the total number of messages 220 related to topic 240 from data feed 120 from a BBS, t is the current date, tᵢ^{news} downloading date of the i^{th} message 220 related to topic 240 from data feed 120 from the source of news, tᵢ^{Blog} is the downloading date of the j^{th} message 220 related to topic 240 from data feed 120 from the blog, tₖ^{BBS} stands for the downloading date of the k^{th} message 220 related to topic 240 from data feed 120 from the BBS, and ω_{news}, ω_{Blog}, ω_{BBS}, λ_{news}, λ_{Blog}, and λ_{BBS} are constants. As an example and not by way of limitation, ω_{news}=1, ω_{Blog}=ω_{BBS}=0.7, and λ_{news}=λ_{Blog}=λ_{BBS}=1. In particular embodiments, a large number of recently downloaded messages 220 associated with topic 240 may indicate topic 240 is popular or relevant, and score calculator 310 may calculate a high score 340 for topic 240. In particular embodiments, score calculator 310 may be configured to write score 290 into ranking-topic-score table 330.

In particular embodiments, rank calculator 320 may be configured to receive score 290. Rank calculator 320 may be configured to determine a ranking 260 for topic 240 based on score 290, and to write the determined ranking 260 to rank topic score table 330. Rank calculator 320 may be configured to determine a higher rank for topic 240 the higher score 290 is. In particular embodiments, using ranking-topic-score table 330, rank calculator 320 may compare a first topic's 240 score 290 with a second topic's 240 score 290 to determine a ranking 260 for the first topic 240.

In particular embodiments, rank calculator 320 may determine a ranking 260 that indicates the popularity or relevance of a topic 240. Ranking 260 may be used to determine or update pricing for particular keyword phrases 270 as topics 240 become more or less popular or relevant. As an example and not by way of limitation, there may be a sudden rise in the number of news articles, blog postings, and BBS messages about oil spills. Computing device 130 may detect a rise in the number of messages relating to oil spills and increase ranking 260 for the keyword phrase 270 “oil.” Pricing engine 280 may then increase price 140 for the keyword phrase 270 “oil.” An increasing price 140 may indicate to potential buyers that keyword phrase 270 is becoming popular or relevant, and may prevent buyers from underbidding on keyword phrase 270.

FIG. 4 is a flowchart illustrating a method of updating prices for keyword phrases using the system of FIG. 1. As provided in FIG. 4, method 400 may begin by receiving a real-time data feed comprising a plurality of messages at step 410. Method 400 may continue by detecting a topic associated with a message in the plurality of messages at step 420. At step 430, method 400 may calculate a score for the topic using temporal data associated with the message. Method 400 may continue by determining a ranking for the topic using the score at step 440. At step 450, method 400 may extract a keyword phrase from the topic. Method 400 may conclude by determining a price associated with the keyword phrase using the determined ranking and/or score at step 460.

In particular embodiments, by analyzing real-time data feeds, method 400 may provide prices that more accurately reflect the true market value of a keyword phrase. These prices may be used by auction administrators or auction systems to prevent a buyer with secret information from underbidding on a keyword phrase that is increasing in popularity or relevance.

Although the present disclosure includes several embodiments, changes, substitutions, variations, alterations, transformations, and modifications may be suggested to one skilled in the art, and it is intended that the present disclosure encompass such changes, substitutions, variations, alterations, transformations, and modifications as fall within the spirit and scope of the appended claims.

What is claimed is:

1. An apparatus comprising:
a receiver configured to receive a respective real-time data feed from each of a source of news, a blog, and a Bulletin Board System (BBS), each real-time data feed comprising a plurality of messages;
a language processor configured to detect a topic associated with a message in the plurality of messages of the respective real-time data feed from each of the source of news, the blog, and the Bulletin Board System (BBS) using natural language processing, the topic indicating the subject of the message, the language processor further configured to extract a keyword phrase from the topic;
a score calculator configured to calculate a score for the topic using temporal data from the message, the score indicating the popularity of the topic, the score calculated by the formula:
$$Score = {ω}_{news} {\sum }_{i = 1}^{{N}_{news}} {e}^{- {λ}_{news} ( t - {t}_{i}^{news} )} + {ω}_{Blog} {\sum }_{j = 1}^{{N}_{Blog}} {e}^{- {λ}_{Blog} ( t - {t}_{j}^{Blog} )} + {ω}_{BBS} {\sum }_{k = 1}^{{N}_{BBS}} {e}^{- {λ}_{BBS} ( t - {t}_{k}^{BBS} )} ,$$
wherein N_{news} is the total number of messages related to the topic from the respective real-time data feed from the source of news,
N_{Blog} is the total number of messages related to the topic from the respective real-time data feed from the blog,
N_{BBS} is the total number of messages related to the topic from the respective real-time data feed from the BBS,
t is the current date,
tᵢ^{news} is the downloading date of the ith message related to the topic from the respective real-time data feed from the source of news,
tⱼ^{Blog} is the downloading date of the jth message related to the topic from the respective real-time data feed from the blog,
tₖ^{BBS} stands for the downloading date of the kth message related to the topic from the respective real-time data feed from the BBS, and
ω_{news}, ω_{Blog}, ω_{BBS}, λ_{news}, λ_{Blog}, and λ_{BBS} are constants;
a rank calculator configured to determine a ranking for the topic using the score;
an engine configured to determine a price for the keyword phrase using the determined ranking and the score, the calculated price indicating a predicted click through rate, the calculated price increasing for a higher predicted click through rate.

2. A method comprising:
receiving, at a computing device, a real-time data feed comprising a plurality of messages;
detecting, by the computing device, a topic associated with a message in the plurality of messages using natural language processing, the topic indicating the subject of the message;
calculating, by the computing device, a score for the topic using temporal data associated with the message, the score indicating the popularity of the topic;
extracting, by the computing device, a keyword phrase from the topic; and
determining, by the computing device, a price associated with the keyword phrase using the score.

3. The method of claim 2, wherein receiving the real-time data feed comprises receiving the real-time data feed from a blog.

4. The method of claim 2, wherein receiving the real-time data feed comprises receiving the real-time data feed from a Bulletin Board System.

5. The method of claim 2, wherein receiving the real-time data feed comprises receiving the real-time data feed from a twitter, a wild, or a social media service.

6. The method of claim 2, wherein the contribution of the message to the calculated score is higher the more recent the message was downloaded.

7. The method of claim 2, wherein calculating the score is based on the timestamp of the message.

8. The method of claim 2, wherein extracting the keyword phrase from the topic comprises using text from the message.

9. The method of claim 2, wherein determining the price is performed in real-time.

10. The method of claim 2, wherein the determined price indicates a predicted click through rate, the determined price increasing for a higher predicted click through rate.

11. The method of claim 2, wherein determining the price comprises determining a higher price when the topic from which the keyword phrase was extracted has a higher calculated score.

12. The method of claim 2, further comprising determining, by the computing device, a ranking for the topic using the score.

13. The method of claim 12, wherein determining the price further comprises determining the price using the ranking.

14. An apparatus comprising:
a receiver configured to receive a real-time data feed, the real-time data feed comprising a plurality of messages;
a language processor configured to detect a topic associated with the message in the plurality of messages using natural language processing, the topic indicating the subject of the message, the language processor further configured to extract a keyword phrase from the topic;
a ranker configured to calculate a score for the topic using temporal data associated with the message, the score indicating the popularity of the topic; and
an engine configured to determine a price associated with the keyword phrase using the score.

15. The apparatus of claim 14, wherein the receiver is configured to receive the real-time data feed from a blog.

16. The apparatus of claim 14, wherein the receiver is configured to receive the real-time data feed from a Bulletin Board System.

17. The apparatus of claim 14, wherein the receiver is configured to receive the real-time data feed from a twitter, a wiki, or a social media service.

18. The apparatus of claim 14, wherein the contribution of the message to the calculated score is higher the more recent the message was downloaded.

19. The apparatus of claim 14, wherein the ranker is configured to calculate the score based on the timestamp of the message.

20. The apparatus of claim 14, wherein the language processor is configured to extract the keyword phrase from the topic using text from the message.

21. The apparatus of claim 14, wherein the engine is configured to determine the price in real-time.

22. The apparatus of claim 14, wherein the determined price indicates a predicted click through rate, the determined price increasing for a higher predicted click through rate.

23. The apparatus of claim 14, wherein the engine is configured to determine a higher price when the topic from which the keyword phrase was extracted has a higher calculated score.

24. The apparatus of claim 14, wherein the ranker is further configured to determine a ranking for the topic using the score.

25. The apparatus of claim 24, wherein the engine is further configured to determine the price using the ranking.
